(19) United States
(12) Patent Application Publication
(10) Pub. No.: US 2009/0016233 A1
(43) Pub. Date: Jan. 15, 2009

(54) Method For Detecting QOS

(75) Inventor: Yonggang Lu, Shenzhen (CN)

Correspondence Address: HARNESS, DICKEY & PIERCE, P.L.C., P.O. BOX 828, BLOOMFIELD HILLS, MI, 48303, US

(73) Assignee: HUAWEI TECHNOLOGIES CO., LTD., Shenzhen (CN)

(21) Appl. No.: 12/211,555

(22) Filed: Sep. 16, 2008

Related U.S. Application Data
(63) Continuation of application No. PCT/CN2007/070825, filed on Sep. 29, 2007.

(30) Foreign Application Priority Data
Sep. 29, 2006 (CN) 200610062951.7

(51) Int. Cl. H04L 12/26

(52) U.S. Cl. 370/252

(57) ABSTRACT

A method for detecting QoS, including: obtaining information in packets transferred between MGWs, and obtaining packet loss ratio, jitter and delay of each channel of users in an office direction in communication with the MGWs through the obtained information; obtaining average packet loss ratio, average delay and average jitter of the office direction according to the packet loss ratio, the jitter and the delay of each channel of users; and obtaining overall QoS of the office direction according to the average packet loss ratio, the average delay and the average jitter of the office direction as well as the weight coefficient of the foregoing three indices affecting the voice quality.

### CROSS-REFERENCE TO RELATED APPLICATIONS

This application is a continuation of International Application No. PCT/CN2007/070825, filed Sep. 29, 2007. This application claims the benefit and priority of Chinese Application No. 200610062951.7, filed Sep. 29, 2006. The entire disclosures of each of the above applications are incorporated herein by reference.

### FIELD

The present disclosure relates to the field of communication technologies and to a method for detecting QoS.

### BACKGROUND

This section provides background information related to the present disclosure which is not necessarily prior art.

As shown in FIG. 1, a typical NGN architecture includes a softswitch and a media gateway (MGW). The softswitch is responsible for call control and the MGW is responsible for conversion of bearer media such as IP. Such devices are in communication with an IP network, and communicate with each other through the IP bearer media. In an IP network, quality of transmission between two packet devices or the bearer quality of data equipment may be deteriorated due to insufficient bearer bandwidth, network channel interruption or network attack. If the Quality of Service (QoS) of the bearer network is not detected in real time, all services will be deteriorated in QoS or even fail. Therefore, it is important for an MGW to monitor and detect the QoS of an IP bearer network in real time.

The RFC1889 defines some indices such as packet loss ratio, jitter, and delay for measuring the QoS of the IP bearer network. However, the RFC1889 does not describe how to use packet loss ratio, jitter and delay to calculate the overall QoS of an IP bearer network. The bearer network QoS indices (packet loss ratio, jitter, delay) calculated out through the Real-time Transport Control Protocol (RTCP) is specific to a single channel of calls, and cannot reflect the IP bearer network QoS of the whole office direction.

### SUMMARY

This section provides a general summary of the disclosure, and is not a comprehensive disclosure of its full scope or all of its features.

The present disclosure provides a method for detecting QoS, through which the IP bearer network QoS of the whole office direction can be obtained.

An embodiment provides a method for detecting QoS, including:

A. obtaining information in packets transferred between MGWs, and obtaining packet loss ratio, jitter and delay of each channel of users in an office direction in communication with the MGWs through the obtained information;

B. obtaining average packet loss ratio, average delay and average jitter of the office direction according to the packet loss ratio, the jitter and the delay of each channel of users; and

C. obtaining overall QoS of the office direction according to the average packet loss ratio, the average delay and the average jitter of the office direction as well as the weight coefficient of the foregoing three indices affecting the voice quality.

Process A further includes:

A1. sending, by a first MGW, packets which indicate each channel of users in the specified office direction in communication with the first MGW to a second MGW through an IP bearer network, in which the packets carry the users' local time and serial numbers;

A2. obtaining, by the second MGW, the users' packet loss ratio according to the recorded serial number and the received packets, upon receiving the packets sent by the first MGW;

A3. sending, by the second MGW, packets which indicate each channel of users in the specified office direction in communication with the second MGW to the first MGW through the IP bearer network, in which the packets carry local time and serial number of the second MGW, the time of receiving the packets from the first MGW, and the obtained users' packet loss ratio; and

A4. by the first MGW, obtaining the users' packet loss ratio, and calculating the delay and the jitter according to the local time of receiving the packets and timestamp carried in the packets, upon receiving the packets sent by the second MGW.

The packet loss ratio is obtained in the following way: the quantity of packets that should be received in the statistic period deducts the quantity of packets actually received in the statistic period, and then the quantity after deduction is divided by the quantity of packets that should be received in the statistic period.

The quantity of packets that should be received in the statistic period is obtained in the following way: the maximum packet serial number in the statistic period deducts the maximum packet serial number in the previous statistic period.

The delay is calculated through the following formula:

Delay=(T4−T1)−(T3−T2)

wherein:

T1 is the time when a first MGW sends a packet; T2 is the time when a second MGW receives the packet; T3 is the time when the second MGW sends a packet; T4 is the time when the first MGW receives the packet.

The jitter is obtained according to the change of delay.

The average packet loss ratio, the average delay, and the average jitter are calculated according to the following formulas:

$$average packet loss ratio in the specified office direction = {\sum }_{0}^{user quantity in specified office direction} packet loss ratio of each user ;$$

$$average delay in the specified office direction = {\sum }_{0}^{user quantity in specified office direction} delay of each user ;$$

$$average jitter in the specified office direction = {\sum }_{0}^{user quantity in specified office direction} jitter of each user .$$

The average packet loss ratio affects voice quality greatly. The average delay and average jitter affect voice quality slightly. The packet is an RTCP packet.

The packet is sent periodically.

The disclosure has the following beneficial effects:

The method for detecting IP bearer network QoS in an embodiment includes:

(i) obtaining the packet loss ratio, jitter and delay of each channel of users in communication with the MGWs according to the information in the packets transferred between MGWs;

(ii) obtaining the average packet loss ratio, average delay and average jitter of the office direction according to the packet loss ratio, jitter and delay of each channel of users; and

(iii) obtaining the IP bearer network QoS of the whole office direction according to the weight of the previous three indices affecting the voice quality, so as to take pertinent measures to notify the softswitch of handling the services differently, improve the real-time monitoring capability of the MGW for monitoring an IP network, and guarantee QoS of existing services.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram of the NGN architecture in the related art;

FIG. 2 is a block diagram of the NGN architecture according to an embodiment; and

FIG. 3 is a flowchart of a method for detecting QoS according to an embodiment.

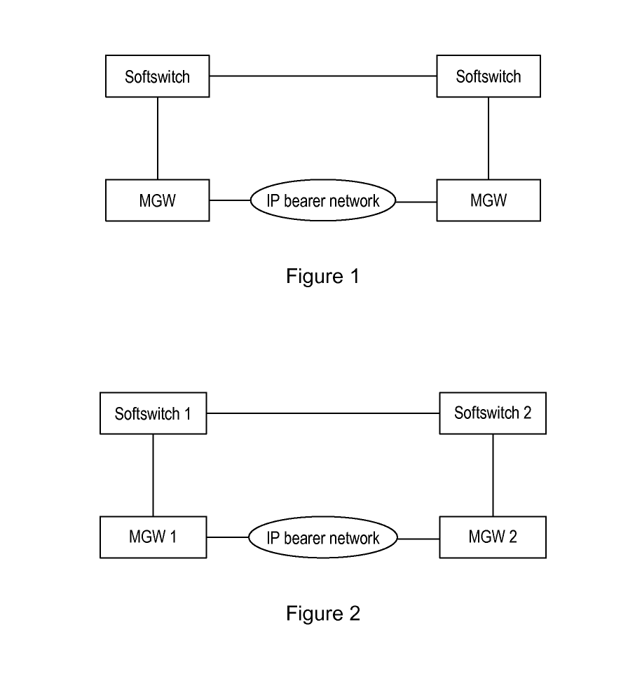

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

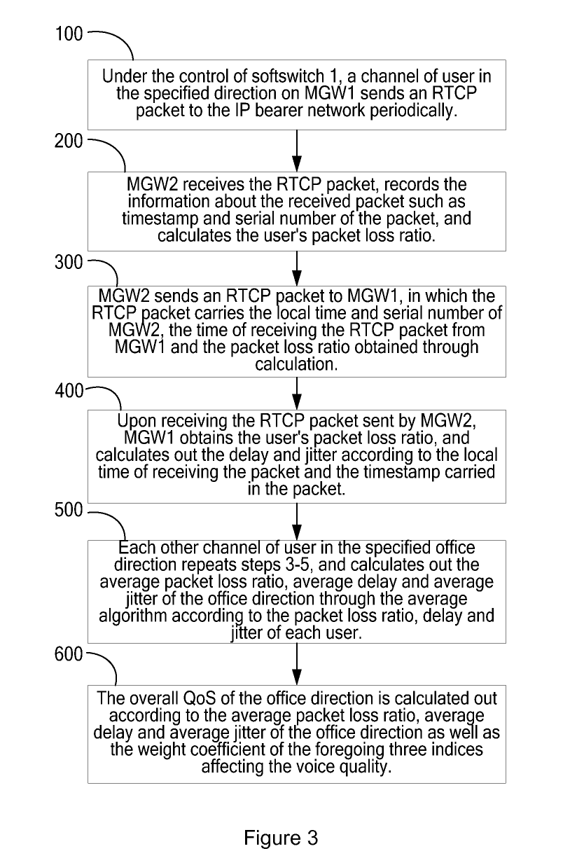

The technical disclosure tests the QoS in a specified office direction by parsing the information in the RTCP packet transferred between MGWs. Referring to FIG. 2 and FIG. 3, the process is described below by taking MGW1 and MGW2 as an example.

In process 100, under the control of softswitch 1, MGW1 sends Real-time Transport Control Protocol (RTCP) packets which indicate a channel of users in an office direction to the IP bearer network periodically, in which the RTCP packets carry the users' local time and serial numbers, the channel of users is in communication with MGW1, and the office direction is specified by softswitch 1 in the delivered message.

In process 200, MGW2 receives the RTCP packets sent by MGW1 from the IP bearer network, records the information in the received packets such as timestamps and serial numbers of the packets, and calculates the users' packet loss ratio according to the recorded serial numbers and the received RTCP packets, where the packet loss ratio is calculated according to the following formulae:

packet loss ratio=(quantity of packets that should be received in the statistic period−quantity of packets actually received in the statistic period)/quantity of RTCP packets that should be received in the statistic period

quantity of packets that should be received in the statistic period=maximum packet serial number in the statistic period−maximum packet serial number in the previous statistic period

In process 300, under the control of softswitch 2, MGW2 sends RTCP packets to MGW1 periodically, in which the RTCP packets carry the local time and serial number of MGW2, the time of receiving the RTCP packets from MGW1 and the packet loss ratio obtained through calculation.

In process 400, upon receiving the RTCP packets sent by MGW2, MGW1 obtains the users' packet loss ratio, and calculates delay and jitter according to the local time of the received RTCP packets and the timestamps carried in the packets according to the following formulas:

Delay=(T4−T1)−(T3−T2)

wherein,

T1 is the time when MGW1 sends an RTCP packet; T2 is the time when MGW2 receives the RTCP packet; T3 is the time when MGW2 sends an RTCP packet; T4 is the time when MGW1 receives the RTCP packet.

Jitter is change of delay. It is supposed that A, B, C and D are times when four packets arrive at MGW2 respectively. B-A is a first delay t1, C-B is a second delay t2, and D-C is a third delay t3. If t1=t2=t3, jitter is 0; if t2 is not equal to t1, t2−t1 is the jitter value. If the jitter is considerable, the voice quality will be affected.

In process 500, each other channel of users in the specified office direction repeats processes 100 to 400, and calculates out average packet loss ratio, average delay and average jitter of the office direction through average algorithm according to the packet loss ratio, the delay and the jitter of each users.

$$Average packet loss ratio in the specified office direction = {\sum }_{0}^{user quantity in specified office direction} packet loss ratio of each user ;$$

$$Average delay in the specified office direction = {\sum }_{0}^{user quantity in specified office direction} delay of each user ; and$$

$$Average jitter in the specified office direction = {\sum }_{0}^{user quantity in specified office direction} jitter of each user .$$

In process 600, the overall QoS of the office direction is calculated according to the average packet loss ratio, the average delay and the average jitter of the office direction as well as the weight coefficient of the previous three indices affecting the voice quality, in which the packet loss ratio affects voice quality greatly, and delay and jitter affect voice quality slightly.

Overall QoS in the specified office direction=Q (average packet loss ratio, average delay, and average jitter of the office direction)

Q (packet loss ratio) Level 0—Packet loss ratio is 0%

Level 1—Packet loss ratio is 3-5%

Level 2—Packet loss ratio is 5-8%

Level 3—Packet loss ratio is 8-15%

Level 4—Packet loss ratio is 15-30%

Level 5—Packet loss ratio is over 30%

Q (delay) Level 0—Delay is less than a preset threshold

Level 1—Delay is greater than a preset threshold

Q (jitter) Level 0—Jitter is less than a preset threshold

Level 1—Jitter is greater than a preset threshold

The overall QoS of the specified office direction is obtained according to the previous process.

The above are preferred embodiments. It is not intended to limit the scope of the present disclosure to these embodiments. Variations and replacements conceivable to those skilled in the art in the spirit of the present disclosure should fall into the protection scope of the present disclosure, and the scope is defined by the accompanying claims.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for detecting QoS, comprising:
obtaining information in packets transferred between MGWs, and obtaining packet loss ratio, jitter and delay of each channel of users in an office direction in communication with the MGWs through the obtained information;
obtaining average packet loss ratio, average delay and average jitter of the office direction according to the packet loss ratio, the jitter and the delay of each channel of users; and
obtaining overall QoS of the office direction according to the average packet loss ratio, the average delay and the average jitter of the office direction as well as the weight coefficient of the foregoing three indices affecting the voice quality.

2. The method of claim 1, wherein the packet loss ratio is obtained in the following way:
the quantity of packets that should be received in the statistic period deducts the quantity of packets actually received in the statistic period, and then the quantity after deduction is divided by the quantity of packets that should be received in the statistic period.

3. The method of claim 2, wherein the quantity of packets that should be received in the statistic period is obtained in the following way: the maximum packet serial number in the statistic period deducts the maximum packet serial number in the previous statistic period.

4. The method of claim 1, wherein the delay is calculated according to the following formula:
Delay=(T4−T1)−(T3−T2)
wherein T1 is the time when a first MGW sends a packet; T2 is the time when a second MGW receives the packet; T3 is the time when the second MGW sends a packet; T4 is the time when the first MGW receives the packet.

5. The method of claim 4, wherein the jitter is obtained according to the change of delay.

6. The method of claim 1, wherein the process of obtaining information in the packet transferred between MGWs, and obtaining the packet loss ratio, the jitter and the delay of each channel of users in the office direction in communication with the MGWs through the obtained information comprises:
sending, by a first MGW, packets which indicate each channel of users in the specified office direction in communication with the first MGW to a second MGW through an IP bearer network, in which the packets carry the users' local time and serial numbers;
obtaining, by the second MGW, the users' packet loss ratio according to the recorded serial number and the received packets, upon receiving the packets sent by the first MGW;
sending, by the second MGW, packets which indicate each channel of users in the specified office direction in communication with the second MGW to the first MGW through the IP bearer network, in which the packets carry local time and serial number of the second MGW, the time of receiving the packets from the first MGW, and the obtained users' packet loss ratio; and
by the first MGW, obtaining the users' packet loss ratio, and calculating the delay and the jitter according to the local time of receiving the packets and timestamp carried in the packets, upon receiving the packets sent by the second MGW.

7. The method of claim 6, wherein the packet loss ratio is obtained in the following way:
the quantity of packets that should be received in the statistic period deducts the quantity of packets actually received in the statistic period, and then the quantity after deduction is divided by the quantity of packets that should be received in the statistic period.

8. The method of claim 7, wherein the quantity of packets that should be received in the statistic period is obtained in the following way: the maximum packet serial number in the statistic period deducts the maximum packet serial number in the previous statistic period.

9. The method of claim 6, wherein the delay is calculated according to the following formula:
Delay=(T4−T1)−(T3−T2)
wherein T1 is the time when a first MGW sends a packet; T2 is the time when a second MGW receives the packet; T3 is the time when the second MGW sends a packet; T4 is the time when the first MGW receives the packet.

10. The method of claim 9, wherein the jitter is obtained according to the change of delay.

11. The method of claim 1, wherein the average packet loss ratio, the average delay and the average jitter are calculated according to the following formulas:
$$average packet loss ratio in the specified office direction = {\sum }_{0}^{user quantity in specified office direction} packet loss ratio of each user ;$$
$$average delay in the specified office direction = {\sum }_{0}^{user quantity in specified office direction} delay of each user ; and$$
$$average jitter in the specified office direction = {\sum }_{0}^{user quantity in specified office direction} jitter of each user .$$

12. The method of claim 1, wherein the packet is a Real-time Transfer Control Protocol, RTCP, packet.

13. The method of claim 1, wherein the packet is sent periodically.

14. A system for detecting QoS, comprising:
means for obtaining information in packets transferred between MGWs, and obtaining packet loss ratio, jitter and delay of each channel of users in an office direction in communication with the MGWs through the obtained information;
means for obtaining average packet loss ratio, average delay and average jitter of the office direction according to the packet loss ratio, the jitter and the delay of each channel of users; and
means for obtaining overall QoS of the office direction according to the average packet loss ratio, the average delay and the average jitter of the office direction as well as the weight coefficient of the foregoing three indices affecting the voice quality.

15. The system of claim 14, wherein means for obtaining information in the packets transferred between MGWs, and obtaining the packet loss ratio, the jitter and the delay of each channel of users in the office direction in communication with the MGWs through the obtained information comprises:
a first MGW, configured to send packets which indicate each channel of users in the specified office direction in communication with the first MGW to a second MGW through an IP bearer network, in which the packets carry the users' local time and serial numbers, receive the packets sent by the second MGW, obtain the users' packet loss ratio, and calculate the delay and jitter according to the local time of receiving the packets and the timestamp carried in the packets;
a second MGW, configured to receive the packets sent by the first MGW and obtain the users' packet loss ratio according to the recorded serial number and the received packets, and send packets which indicate each channel of users in the specified office direction in communication with the second MGW to the first MGW through the IP bearer network, in which the packets carry local time and serial number of the second MGW, the time of receiving the packets from the first MGW, and the obtained users' packet loss ratio.
